(19) United States
(12) Patent Application Publication
(10) Pub. No.: US 2016/0165682 A1
(43) Pub. Date: Jun. 9, 2016

(54) LED DRIVING CIRCUIT OF MULTI-STAGE SWITCH BULB LAMP

(71) Applicant: UNITY OPTO TECHNOLOGY CO., LTD., NEW TAIPEI CITY (TW)

(72) Inventors: CHIH-HSIEN WU, NEW TAIPEI CITY (TW); WEI CHANG, NEW TAIPEI CITY (TW); HUAN-YING LU, NEW TAIPEI CITY (TW); KAI-CHENG CHUANG, NEW TAIPEI CITY (TW); SHAO-WEI CHIU, NEW TAIPEI CITY (TW)

(21) Appl. No.: 14/621,993

(22) Filed: Feb. 13, 2015

(30) Foreign Application Priority Data
Dec. 5, 2014 (TW) 103142343

(51) Int. Cl. H05B 33/08

(52) U.S. Cl. CPC H05B 33/0809; H05B 33/0845

(57) ABSTRACT

An LED driving circuit of a multi-stage switch bulb lamp includes a power modulation module having a first switch, a second switch, a first transistor, a second transistor, a first resistor, a second resistor, a third resistor and a fourth resistor. The first and second switches are respectively and serially connected to the first and second transistors, the first transistor is electrically connected to the second resistor, the other end of the second resistor is serially connected to the third resistor to form a reference voltage node and has a reference voltage, the first and second transistors are electrically connected to the reference voltage node, the other end of the third resistor is serially connected to the fourth resistor, and the second transistor is electrically connected to the third resistor. The first and second switches may be turned on/off to adjust the reference voltage value and change the power.

### CROSS-REFERENCE TO RELATED APPLICATIONS

This non-provisional application claims priority under 35 U.S.C. §119(a) on Patent Application No(s). 103142343 filed in Taiwan, R.O.C. on Dec. 5, 2014, the entire contents of which are hereby incorporated by reference.

### BACKGROUND OF THE INVENTION

1. Field of the Invention

The present invention relates to the field of LED driving circuits, and more particularly to an LED driving circuit of a multi-stage switch bulb lamp capable of controlling the power for linear dimming.

2. Description of the Related Art

Illumination system is indispensible to our daily life and provided as a light aid in dark places. In order to provide appropriate brightness in an environment, a conventional dimmer is generally designed with a three-stage switch to adjust the brightness of a bulb, so as to provide different illumination levels according to the change of the natural light source and improve the convenience of use.

With reference to FIG. 1 for an exploded view of a conventional LED bulb lamp, a three-stage switch structure 7 of an LED bulb lamp is comprised of an upper lamp holder 71, an insulating pad 72, a lamp base 73 and a lower lamp holder 74 sequentially combined with each other from top to bottom. The upper lamp holder includes a wire hole 711, and the lamp base 73 includes a switch 731, a first contact 732, a second contact 733 and a lamp slot 734, and the lower lamp holder 74 includes an insulating cylinder. An external power cable is passed through the wire hole 711 and the insulating pad 72 and electrically coupled to the first contact 732 and the second contact 733, and the LED bulb lamp is rotated and installed into the lamp slot 734. The switch 73 is a three-stage switch, so that the LED bulb lamp has three different levels of brightness and provides an easy dimming effect. However, the environmental conditions and factors are complicated, the three-stage switch can just provide three different illumination modes (high, middle, and low brightness) only, but it cannot provide a precise dimming effect and adjust the lamp to the most appropriate brightness with a good power saving mechanism. Therefore, it is an important subject for related manufacturers to further improve the power saving effect to meet the environmental protection requirements while providing a precise dimming mode for the LED lamps.

In view of the problems of the conventional LED bulb lamps, the inventor of the present invention designed and developed an LED bulb lamp with a multi-stage switch for switching the power within a rated range to perform a linear dimming, so as to achieve the effects of adjusting the lamp to an optimized illumination level and saving power.

### SUMMARY OF THE INVENTION

In view of the aforementioned problems of the prior art, it is a primary objective of the present invention to provide an LED driving circuit of a multi-stage switch bulb lamp with a multi-stage switch power control mechanism for changing the brightness of an LED or an LED bulb lamp by the switch and dimming the lamp linearly within a rated power range, so that the invention can adjust the lamp to the best brightness and save power in different environmental conditions.

To achieve the aforementioned objective, the present invention provides an LED driving circuit of a multi-stage switch bulb lamp with a large power mode, a middle power mode and a small power mode, comprising: a power modulation module, further comprising a first input unit, a second input unit, a first switch, a second switch, a first transistor, a second transistor, a first resistor, a second resistor, a third resistor, a fourth resistor and a capacitor, wherein the first resistor, the second resistor, the third resistor and the fourth resistor have a resistance of R21, R22, R23, and R24 respectively; the first input unit is electrically coupled to the first switch, and the second input unit is electrically coupled to the second switch; the first switch and the second switch are respectively and electrically coupled to the first transistor and the second transistor; the first resistor and the second resistor are connected in series to form a first voltage dividing node, and the first transistor is electrically coupled to the first voltage dividing node; the other end of the second resistor and the third resistor are connected in series to form a reference voltage node and have a reference voltage, and the first transistor and the second transistor are electrically coupled to the reference voltage node; the other end of the third resistor and the fourth resistor are connected in series to form a second voltage dividing node, and the second transistor is electrically coupled to the second voltage dividing node, and the other end of the fourth resistor is electrically coupled to the capacitor, and the other end of the capacitor is electrically coupled to the reference voltage node; thereby, when the first switch is on and the second switch is off, the large power mode is enabled, wherein the reference voltage of the large power mode is 2.5*(R23+R24)/(R21+R23+R24); when both of the first switch and the second switch are off, the middle power mode is enabled, wherein the reference voltage of the middle power mode is 2.5*(R23+R24)/(R21+R22+R23+R24); when both of the first switch and the second switch are on, the small power mode is enabled, wherein the reference voltage of the small power mode is 2.5*R24/(R21+R22+R24); and the first switch and the second switch may be switched to change the value of the reference voltage to control the power of the LED driving circuit of a multi-stage switch bulb lamp.

The aforementioned LED driving circuit of a multi-stage switch bulb lamp further comprises a rectification module, a conversion module and a control module, wherein and the first input unit and the second input unit are respectively and electrically coupled to the rectification module, the rectification module is electrically coupled to the conversion module, the conversion module is electrically coupled to a plurality of light emitting diodes (LEDs) and generates a driving voltage to drive the LEDs, the other end of the capacitor is electrically coupled to the control module, and the control module is electrically coupled to the conversion module to control the power of the LEDs in different stages and dim the lamp within a power range. The invention determines the use of a particular power mode according to the environmental condition and applies the dimming mechanism to adjust the light and brightness to the most appropriate status.

In the aforementioned LED driving circuit, the conversion module includes a boost inductor and a conducting diode installed therein, and the rectification module is electrically coupled to the boost inductor, and the other end of the boost inductor is electrically coupled to the conducting diode, and the other end of the conducting diode is electrically coupled to the LEDs to output the driving voltage to the LEDs.

In the aforementioned LED driving circuit, the power modulation module further includes a sample voltage source electrically coupled to the other end of the first resistor and the control module to provide a sample signal to the control module, and the sample signal is provided to the control module and serves as a basis for signal comparison.

In the aforementioned LED driving circuit, the control module further includes a controller electrically coupled to the sample voltage source for receiving the sample signal, and the controller is electrically coupled to the other end of the capacitor for receiving the reference voltage.

In the aforementioned LED driving circuit, an end of the conducting diode is electrically coupled to the controller, and the other end of the conducting diode is electrically coupled to the controller through a switch, and the controller is electrically coupled to the LEDs for receiving from the LEDs to detect whether the driving voltage is too high.

In the aforementioned LED driving circuit, the sample voltage source is electrically coupled to the controller for providing the sample signal to the controller, and the sample signal is provided to the controller and serves as a basis for signal comparison.

The LED driving circuit of a multi-stage switch bulb lamp of the present invention switches the first switch and the second switch to change the value of the reference voltage to control the power of the LED driving circuit of a multi-stage switch bulb lamp, and the LED driving circuit may be applied to an LED bulb lamp or an LED, and the control module dims the LED driving circuit of a multi-stage switch bulb lamp within a rated power range, so that the present invention can adjust the lamp to the best brightness and save power in different environmental conditions.

### BRIEF DESCRIPTION OF THE DRAWINGS

FIG. 1 is an exploded view of a prior art;

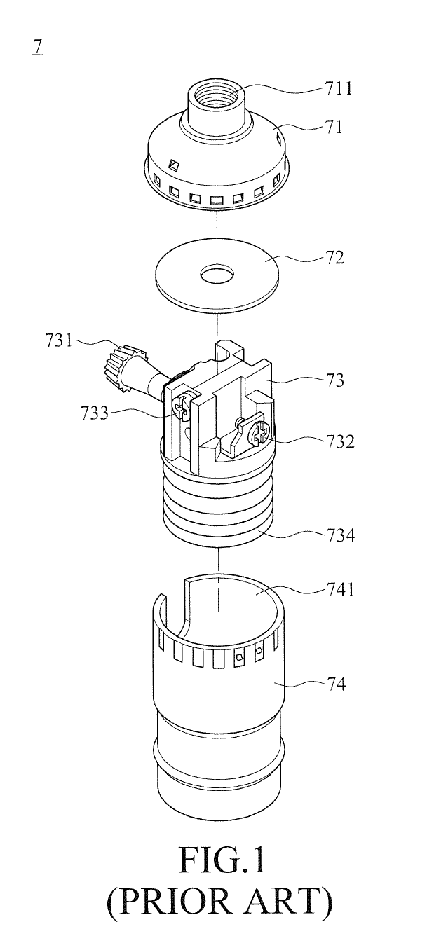

FIG. 2 is a schematic circuit diagram of a power modulation module of a preferred embodiment of the present invention;

FIG. 3 is a schematic block diagram of a preferred embodiment of the present invention; and

FIG. 4 is a schematic circuit diagram of a preferred embodiment of the present invention.

### DETAILED DESCRIPTION OF THE PREFERRED EMBODIMENTS

The aforementioned and other objectives, technical characteristics and advantages of the present invention will become apparent with the detailed description of preferred embodiments and the illustration of related drawings as follows.

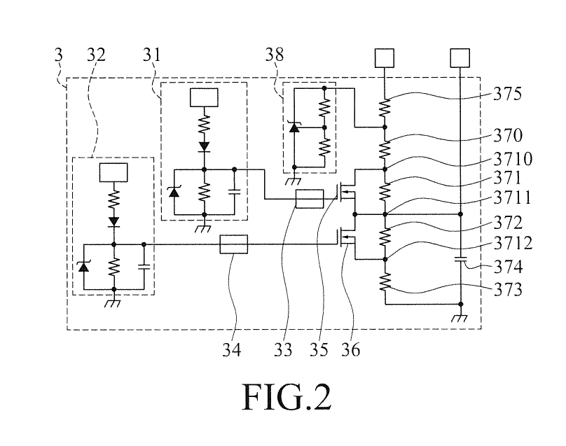

With reference to FIG. 2 for a schematic circuit diagram of a power modulation module of a preferred embodiment of the present invention, this embodiment adopts a three-stage power switch to illustrate the present invention, and an LED driving circuit of a multi-stage switch bulb lamp 1 of the invention comes with a large power mode, a middle power mode and a small power mode and comprises: a power modulation module 3 for adjusting power to achieve the effect of a multi-stage power output, and having a first input unit 31, a second input unit 32, a first switch 33, a second switch 34, a first transistor 35, a second transistor 36, a first resistor 370, a second resistor 371, a third resistor 372, a fourth resistor 373 and a capacitor 374. The first resistor 370, the second resistor 371, the third resistor 372 and the fourth resistor 373 have the resistance of R21, R22, R23, and R24 respectively; the first input unit 31 is electrically coupled to the first switch 33; the second input unit 32 is electrically coupled to the second switch 34; the first input unit 31 and the second input unit 32 are provided for receiving external power and converting and transmitting the power to the first switch 33 and the second switch 34 respectively; the other end of the first switch 33 and the other end of the second switch 34 are respectively and electrically coupled to the first transistor 35 and the second transistor 36; the first resistor 370 and the second resistor 371 are connected in series to form a first voltage dividing node 3710; the first transistor 35 is electrically coupled to the first voltage dividing node 3710; the other end of the second resistor and the third resistor 372 are connected in series to form a reference voltage node 3711 and has a reference voltage; the first transistor 35 and the second transistor 36 are electrically coupled to the reference voltage node 3711; the first transistor 35 and the second transistor 36 are signal biasing components; the other end of the third resistor 372 and the fourth resistor 373 are connected in series to form a second voltage dividing node 3712; the second transistor 36 is electrically coupled to the second voltage dividing node 3712; the other end of the fourth resistor 373 is electrically coupled to the capacitor 374; the other end of the capacitor 374 is electrically coupled to the reference voltage node 3711; the capacitor 374 has an energy saving effect; and the point of intersection of the serially connected reference voltage node 3711 and capacitor 374 is equipotential.

If the first switch 33 is ON and the second switch 34 is OFF, the large power mode will be enabled, wherein the reference voltage of the large power mode is 2.5*(R23+R24)/(R21+R23+R24); if both first switch 33 and second switch 34 are OFF, the middle power mode will be enabled, wherein the reference voltage of the middle power mode is 2.5*(R23+R24)/(R21+R22+R23+R24); and if both first switch 33 and second switch 34 are ON, the small power mode will be enabled, wherein the reference voltage of the small power mode is 2.5*R24/(R21+R22+R24). By switching the first switch 33 and the second switch 34, the value of the reference voltage can be changed to control the power of the LED driving circuit of a multi-stage switch bulb lamp 1, so as to achieve the effect of controlling the power in three stages (Large, Middle, and Small) to change the illumination brightness of the LEDs 6.

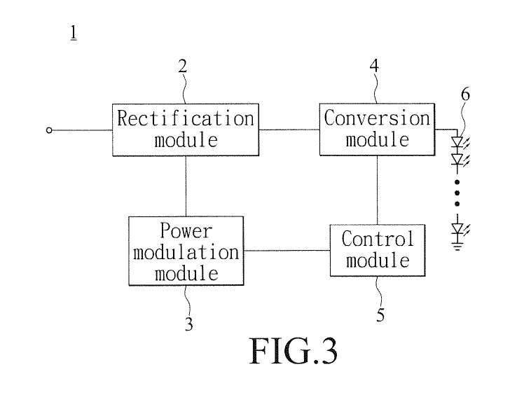

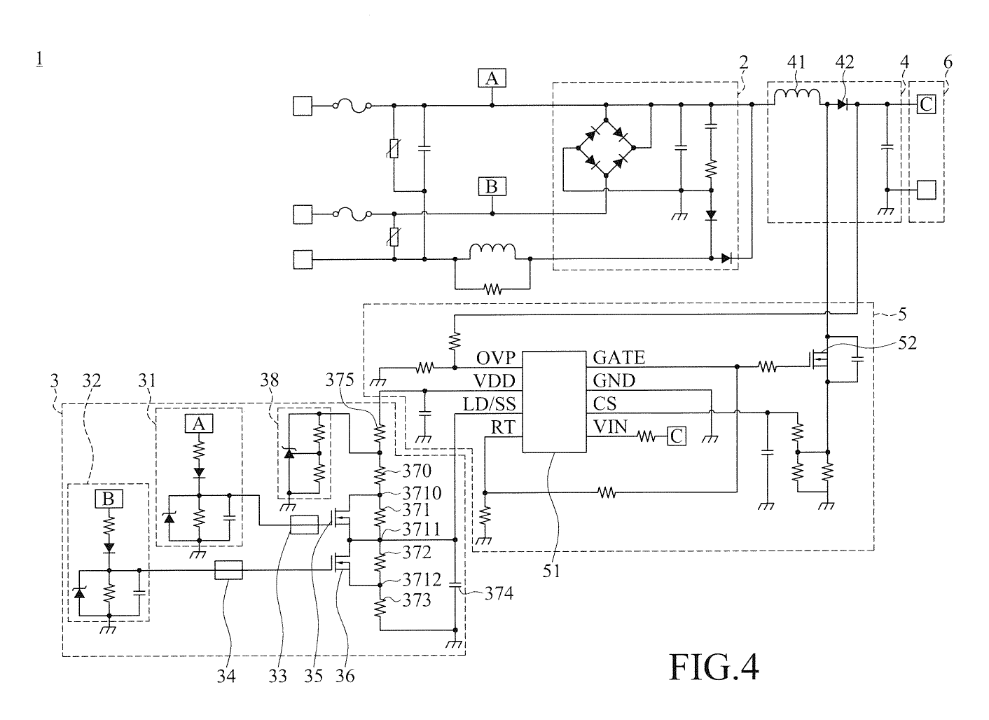

With reference to FIGS. 3 and 4 for a schematic block diagram and a schematic circuit diagram of an LED driving circuit of a multi-stage switch bulb lamp 1 in accordance with a preferred embodiment of the present invention respectively, the LED driving circuit of a multi-stage switch bulb lamp 1 further comprises a rectification module 2, a conversion module 4 and a control module 5, and the first input unit 31 and the second input unit 32 are electrically coupled to the rectification module 2, and the first input unit 31 and the second input unit 32 are used to receive a signal from the rectification module 2 and convert and transmit the signal to the first switch 33 and the second switch 34, and the rectification module 2 is electrically coupled to the conversion module 4 and provided for transmitting the rectified signal to the conversion module 4, and the conversion module 4 is electrically coupled to a plurality of LEDs 6 for generating a driving voltage to drive the LEDs 6, and the other end of the capacitor 374 is electrically coupled to the control module 5, and the reference voltage is transmitted from this path to the control module 5, and the control module 5 is electrically coupled to the conversion module 4 for controlling the power of the LEDs 6 in different stages and dimming the light within a power range, and thus the LED driving circuit of a multi-stage switch bulb lamp 1 has the effects of controlling power in three stages, dimming light precisely, and saving power.

In FIG. 4, the control module 5 further includes a controller 51 electrically coupled to the conversion module 4 for detecting a voltage level of the conversion module 4. The controller 51 is electrically coupled to the other end of the capacitor 374 for receiving the reference voltage. The controller 51 is also electrically coupled to the LEDs 6 and provided for detecting whether the driving voltage outputted to the LEDs 6 is too high, so as to prevent the LEDs 6 from being burned or damaged.

In FIG. 4, the conversion module 4 includes a boost inductor 41 and a conducting diode 42 installed therein, and the rectification module 2 is electrically coupled to the boost inductor 41, and the other end of the boost inductor 41 is electrically coupled to the conducting diode 42, and the boost inductor 41 has the effects of boosting voltage and storing energy. The other end of the conducting diode 42 is electrically coupled to the LEDs 6 to output the driving voltage to the LEDs 6, and the conducting diode 42 is provided for preventing the driving voltage from feeding from the LEDs 6 back to the rectification module 2.

Further, an end of the conducting diode 42 is electrically coupled to the controller 51 for detecting whether the voltage outputted from the boost inductor 41 to the conducting diode 42 is too high. The other end of the conducting diode 42 is electrically coupled to the controller 51 through a switch 52 for adjusting the brightness of the LEDs 6.

In FIG. 4, the power modulation module 3 further includes a sample voltage source 38 electrically coupled to the other end of the first resistor 37, and the sample voltage source 38 is electrically coupled to the controller 51 through a voltage-dividing resistor 375 for providing a sample signal to the controller 51, and the sample signal is provided to the controller 51 to serve as a basis of signal comparison, and the voltage of the sample signal is divided by the voltage-dividing resistor 375 and the first resistor 370 and determined by the voltage drop of the voltage-dividing resistor 375.

In the LED driving circuit of a multi-stage switch bulb lamp 1 in accordance with the present invention, the first switch 33 and the second switch 34 may be switched to generate a bias voltage to the first transistor 35 and the second transistor 36, and the voltage dividing status of the first resistor 370, the second resistor 371, the third resistor 372 and the fourth resistor 373 may be changed to adjust the value of the reference voltage to control the power of the LED driving circuit of a multi-stage switch bulb lamp 1, and the present invention may be applied to an LED bulb lamp or an LED driving circuit, and the conducting diode 42 has the effect of preventing the driving voltage from feeding from the LEDs 6 back to the rectification module 2, and the control module 5 detects the driving voltage of the LEDS 6 and adjust the driving voltage to effectively prevent the LEDS 6 from being burned or damaged. In the meantime, the control module 5 and the conversion module 4 provide the effect of adjusting power of the LED driving circuit of a multi-stage switch bulb lamp 1 in different stages, and perform a linear dimming effect precisely within a power range. We take the following three occasions for example. The large power mode is adopted for reading that requires a higher brightness, and the linear dimming effect is used to adjust the brightness to a comfortable and non-glare condition, so that our eyes will not less susceptible to fatigue. The middle power mode is adopted for dining that requires a soft and warm light, and the light is dimmed linearly to maintain a good dining atmosphere. The small power mode is adopted for sleeping, and the light is adjusted to an appropriate brightness for sleeping according to a user's personal preference. In summation, the invention can adjust the lamp to the best brightness and save power in different environmental conditions.

What is claimed is:

1. An LED driving circuit of a multi-stage switch bulb lamp, with a large power mode, a middle power mode and a small power mode, comprising:
a power modulation module, further comprising a first input unit, a second input unit, a first switch, a second switch, a first transistor, a second transistor, a first resistor, a second resistor, a third resistor, a fourth resistor and a capacitor, wherein the first resistor, the second resistor, the third resistor and the fourth resistor have the resistance of R21, R22, R23, and R24 respectively; the first input unit is electrically coupled to the first switch, and the second input unit is electrically coupled to the second switch; the first switch and the second switch are respectively and electrically coupled to the first transistor and the second transistor; the first resistor and the second resistor are connected in series to form a first voltage dividing node, and the first transistor is electrically coupled to the first voltage dividing node; an another end of the second resistor and the third resistor are connected in series to form a reference voltage node and have a reference voltage, and the first transistor and the second transistor are electrically coupled to the reference voltage node; an another end of the third resistor and the fourth resistor are connected in series to form a second voltage dividing node, and the second transistor is electrically coupled to the second voltage dividing node, and an another end of the fourth resistor is electrically coupled to the capacitor, and an another end of the capacitor is electrically coupled to the reference voltage node;
thereby, when the first switch is on and the second switch is off, the large power mode is enabled, wherein the reference voltage of the large power mode is 2.5*(R23+R24)/(R21+R23+R24);
when both of the first switch and the second switch are off, the middle power mode is enabled, wherein the reference voltage of the middle power mode is 2.5*(R23+R24)/(R2.1+R22+R23+R24);
when both of the first switch and the second switch are on, the small power mode is enabled, wherein the reference voltage of the small power mode is 2.5*R24/(R21+R22+R24); and
the first switch and the second switch may be switched to change the value of the reference voltage to control the power of the LED driving circuit of a multi-stage switch bulb lamp.

2. The LED driving circuit of claim 1, further comprising a rectification module, a conversion module and a control module, and the first input unit and the second input unit being respectively and electrically coupled to the rectification module, and the rectification module being electrically coupled to the conversion module, and the conversion module being electrically coupled to a plurality of light emitting diodes (LEDs) and generating a driving voltage to drive the LEDs, and the other end of the capacitor being electrically coupled to the control module, and the control module being electrically coupled to the conversion module to control the power of the LEDs in different stages and dim the lamp within a power range.

3. The LED driving circuit of claim 2, wherein the conversion module includes a boost inductor and a conducting diode installed therein, and the rectification module is electrically coupled to the boost inductor, and the other end of the boost inductor is electrically coupled to the conducting diode, and the other end of the conducting diode is electrically coupled to the LEDs to output the driving voltage to the LEDs.

4. The LED driving circuit of claim 3, wherein the power modulation module further includes a sample voltage source electrically coupled to the other end of the first resistor and the control module to provide a sample signal to the control module.

5. The LED driving circuit of claim 4, wherein the control module further includes controller electrically coupled to the sample voltage source for receiving the sample signal, and the controller is electrically coupled to the other end of the capacitor for receiving the reference voltage.

6. The LED driving circuit of claim 5, wherein the conducting diode has an end electrically coupled to the controller and the other end switch electrically coupled to the controller through a switch, and the controller is electrically coupled to the LEDs for detecting whether the driving voltage is too high.

7. The LED driving circuit of claim 6, wherein the sample voltage source is electrically coupled to the controller for providing the sample signal to the controller.
